(19) United States
(12) Patent Application Publication
(10) Pub. No.: US 2016/0234522 A1
(43) Pub. Date: Aug. 11, 2016

(54) Video Decoding

(71) Applicant: Microsoft Technology Licensing, LLC, Redmond, WA (US)

(72) Inventors: Mei-Hsuan Lu, Bellevue, WA (US); Satya Sasikanth Bendapudi, Redmond, WA (US)

(21) Appl. No.: 14/615,395

(22) Filed: Feb. 5, 2015

(51) Int. Cl. H04N 19/463; H04N 19/70; H04N 19/85; H04N 19/44

(52) U.S. Cl. CPC H04N 19/463; H04N 19/44; H04N 19/70; H04N 19/85

(57) ABSTRACT

Video content is relayed from a transmitting device to a receiving device via a video relay server. The content comprises a plurality of frames. Before encoding, each of the plurality of frames is formed of a respective array of desired image data to be displayed at the receiving device. Filler image data is added to each of the plurality of frames before encoding. Control data is generated, which comprises cropping data indicating that none, or only some, of the filler image data should be cropped out before the plurality of frames is displayed. The encoded video content and the control data is transmitted to the server. At the server, the filler image data is detected automatically; in response, the cropping data is modified to indicate that all of the filler data should be cropped out before displaying the frames.

### BACKGROUND

In modern communications systems a video signal may be sent from one device to another over a medium such as a wired and/or wireless network, often a packet-based network such as the Internet. Typically video content, i.e. data which represents the values (e.g. chrominance, luminance) of individual samples in slices of the video, is encoded by an encoder at the transmitting device in order to compress the video content for transmission over the network. Note the term “pixel” herein means an individual sample of the video content itself, and as such is an inherent property of the video content which may or may not correspond to a display element of a display on which the video content is to be displayed. A “slice” means a video frame or region of a video frame i.e. a frame is comprised of one or more slices.

The encoding for a given slice may comprise intra frame encoding whereby 16×16 pixel (macro)blocks are encoded relative to other blocks in the same slice. In this case a target block is encoded in terms of a difference (the residual) between that block and a neighbouring block. Alternatively the encoding for some frames or slices may comprise inter frame encoding whereby blocks in the target slice are encoded relative to corresponding portions in a preceding frame, typically based on motion prediction. In this case a target block is encoded in terms of a motion vector identifying an offset between the block and the corresponding portion from which it is to be predicted, and a difference (the residual) between the block and the corresponding portion from which it is predicted. The residual data may then be subject to transformation into frequency coefficients, which are then subject to quantization whereby ranges of frequency coefficients are compressed to single values. Finally, lossless encoding such as entropy encoding may be applied to the quantized coefficients. A corresponding decoder at the receiving device decodes the slices of the received video signal based on the appropriate type of prediction, in order to decompress them for output on a display. Prior to compression and following decompression, each video frame of the video content is represented in the spatial domain as a two dimensional array (2-dimensional data set) of image data in the form of pixels values. Herein, the terms “top rows” and “bottom rows” of the array refer to the pixels representing the uppermost and lowermost parts of an image as it is to be displayed respectively. The array has a column height H in pixels (pixel height) and a row width W in pixels (pixel width); “WxH” is defined as the resolution of the video frame, and the ratio “W:H” is defined as the aspect ratio of the video frame. For completeness, it is noted that both the resolution and aspect ratio used herein are also inherent properties of the video content. The notation “Hp” denotes pixel height e.g. 240p means a pixel height of 240 pixels.

Once the video content has been encoded, the encoded video content is structured for transmission via the network. The coded video content may be divided into packets, each containing an encoded slice. For example, the H.264 and HEVC (High Efficiency Video Coding) standards define a Video Coding Layer (VCL) at which the (e.g. inter/intra) encoding takes place to generate the coded video content (VCL data), and a Network Abstraction Layer (NAL) at which the VCL data is encapsulated in packets—called NAL units (NALUs)—for transmission. The VCL data represents pixel values of the video slices. Non-VCL data, which generally includes encoding parameters that are applicable to a relatively large number of frames, is also encapsulated in NALUs at the NAL. Each NALU has a payload which contains either VCL or non-VCL data (not both) in byte (8 bit)-format, and a two-byte header which among other things identifies the type of the NALU. A similar format is also adopted in SMPTE VC-1 standard.

The NAL representation is intended to be compatible with a variety of network transport layer formats, as well as with different types of computer-readable storage media. Some packet-orientated transport layer protocols provide a mechanism by which the VCL/non-VCL can be carried in packets framed by the transport layer protocol itself. Other stream-orientated transport layer protocols do not. With a view to the latter, an H.264 byte stream format is defined, whereby the raw NAL data—comprising encoded VCL data, non-VCL data and NALU header data—may be represented and received at the transport layer of the network for decoding, or from local computer storage, as a stream of bytes, in which the packets are framed by special marker byte sequences included in the coded data itself. Note, a “packet stream” means a sequence of packets (e.g. NALUs) which is received, and which thus becomes available, over time so that processing of earlier parts of the stream can commence before later parts of the stream have been received. The “packet stream” terminology is not limited to any particular packet framing mechanism—and for completeness it is noted that both of the aforementioned types of framing mechanism are covered by the terminology—nor does it require the packets to be received in the correct order (i.e. that in which they are intended to be outputted).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Video content is relayed from a transmitting device to a receiving device via a video relay server. The content comprises a plurality of frames. Before encoding, each of the plurality of frames is formed of a respective array of desired image data to be displayed at the receiving device. Filler image data extending horizontally across the top and bottom of each of the plurality of frames, is added to each of the plurality of frames before encoding. For example, the transmitting device may include this filler data for legacy reasons. Control data is generated, which comprises cropping data indicating that none, or only some, of the filler image data should be cropped out before the plurality of frames is displayed. The filler image data may for instance be in the form of black (zero-valued) pixels. The term “black bars” as it is used herein refers to that filler data which has been added by the encoder but which the encoder has not indicated should be cropped out. The encoded video content and the control data is transmitted to the server. At the server, the filler image data is detected automatically; in response, the cropping data is modified to indicate that all of the filler data should be cropped out before displaying the frames. That is, to indicate that the black bars should be cropped out, along with any further filler data which the encoder has already indicated should be cropped out if there is any such further filler.

A first aspect of the subject matter is directed to a method for relaying video content from a transmitting device to a receiving device of a communication system. The following steps are performed at the transmitting device. Video content to be transmitted to the receiving device is received. The video content comprises a plurality of frames, each of the plurality of frames formed of a respective array of desired image data to be displayed at the receiving device. The video content is pre-processed to add filler image data to each of the plurality of frames as more than a predetermined number of additional rows at the top and more than said predetermined number of additional rows at the bottom of the respective array. The pre-processed video content is encoded. Control data for decoding and displaying the plurality of video frames is generated. The control data comprises cropping data indicating that between zero and said predetermined number of topmost rows, inclusive, and between zero and said predetermined number of bottommost rows, inclusive, should be cropped out of each of the plurality of frames before the plurality of video frames is displayed, thereby indicating that at least some of the additional rows should be displayed when the video content is outputted. The encoded video content and the control data are transmitted as a packet stream to a video relay server of the system. The following steps are performed at the video relay server. The packet stream is received. Stream processing code is executed on a processor of the video relay server to cause the following operations. At least part of the received packet stream is processed to automatically detect the filler image data. In response to said detection, the packet stream is modified by modifying the cropping data to indicate that all of the additional rows should be cropped out of each of the plurality of video frames before the plurality of video frames is displayed. The modified stream is transmitted to the receiving device.

A second aspect of the subject matter is directed to a video relay server comprising a network interface configured to receive the aforementioned data stream, a processor, and a memory holding the aforementioned stream processing code for execution on the processor of the relay server. A third aspect of the subject matter is directed to a computer program product comprising the aforementioned stream processing code stored on a computer readable storage medium. A fourth aspect of the subject matter is directed to a communication system comprising the aforementioned transmitting device and relay server. Note the stream processing code of any of these various aspects of the subject matter may be configured in accordance with any of the embodiments disclosed herein.

### BRIEF DESCRIPTION OF FIGURES

To aid understanding of the subject matter and to show how the same may be carried into effect, reference will now be made to the following figures in which:

FIG. 1 shows a schematic block diagram of communication system;

FIG. 2 schematically illustrates representations of video data at a Network Abstraction Layer and a Video Coding Layer;

FIG. 3 shows a function block diagram of a video decoder;

FIG. 4 is schematically illustrates a mechanism for communication between a telepresence conferencing system (VTC) and a user device via a video interoperability server (VIS), and includes a function block diagram of the VTC and a block diagram of the VIS;

FIG. 5 is a flow chart for a stream processing algorithm implemented by executing stream processing code;

FIGS. 6A and 6B show an example of how a client user interface may respond to changes in a video stream in existing types of communication system;

FIGS. 7A and 7B show another example of how a client user interface may respond to changes in a video stream in existing types of communication system.

### DETAILED DESCRIPTION OF EMBODIMENTS

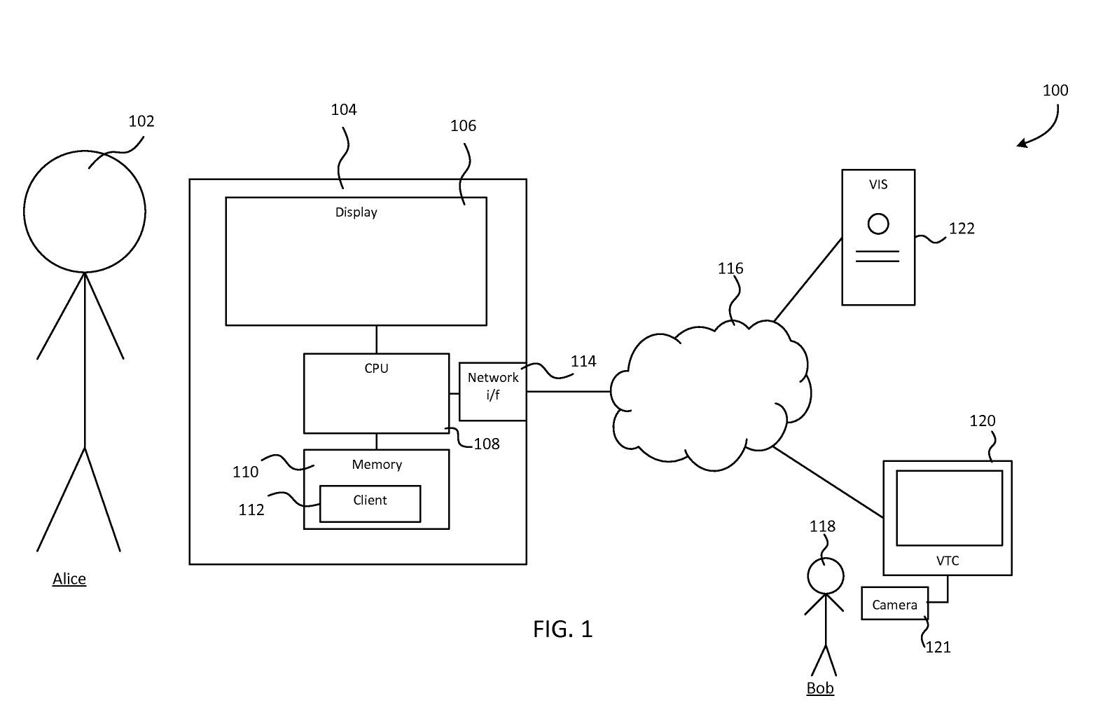

FIG. 1 shows a communication system 100, which comprises a network 116, a receiving device in the form of a user device 104 accessible to a user 102 (Alice), a transmitting device in the form of a video telepresence conferencing system (VTC) 120 accessible to another user 118 (Bob), and a video interoperability server (VIS) 122 (video relay server). The user device 104, VIS 122 and VTC 120 are connected to the network 116. The network 116 has network layers, including a transport layer which provides end-to-end communication between different network endpoints such as the devices 104, 120 and the server 122.

The user device 104 comprises a processor, e.g. formed one or more CPUs (Central Processing Unit) 108, to which is connected a network interface 144—via which the user device 114 is connected to the network 116—a computer readable storage medium (memory) 110 which holds software i.e. executable code, and in particular a communication client 112, and a display 106. The user device 104 is a computer device which can take a number of forms e.g. that of a desktop or laptop computer device, mobile phone (e.g. smartphone), tablet computing device, wearable computing device, television (e.g. smart TV), set-top box, gaming console etc.

The client 112 (which may be e.g. a stand-alone communication client application, plugin to another application such as a Web browser etc.) enables real-time video calls, e.g. VoIP (“voice over IP”) calls, to be established between the user device 104 and the VTC 120 via the network 116 so that the user 102 and the other user 118 can communicate with one another via the network 116. The call is established via the VIS 120, which provides interoperability between the devices 104, 102 (see below). A camera 121 of the VTC captures raw (i.e. uncompressed) video content, which is encoded by the VTC 120 and transmitted to the VIS 122 via the network 116 as a packet stream. The stream may for example be encoded according to the H.264, VC-1 or HEVC standard. The stream comprises both video data packets, which contain the encoded video content, and one or more related control packets, each containing control data which will be needed by any other device if the client 112 is to be able to decode and correctly display the part of the video content to which that control packet relates.

The interoperability server 122 processes the stream and, where necessary, modifies the stream so that it is optimized for playback by the client 112. This is descried in detail below. The VIS 122 then transmits the modified stream to the client 112 running on the user device 104.

The client 112 receives the modified stream, and decodes and displays the video content contained therein using the control data.

The client 112 provides a user interface (UI) for receiving information from and outputting information to the user 102, including the decoded video content. For instance, the client 112 can control the display 106 to output information to the user 102 in visual form, including to output the decoded video content. The display 104 may comprise a touchscreen so that it functions as both an input and an output device, and may or may not be integrated in the user device 104 e.g. it may be part of a separate device, such as a headset, smartwatch etc., connectible to the user device 104 via suitable interface.

The user interface may comprise, for example, a Graphical User Interface (GUI) which outputs information via the display 106 and/or a Natural User Interface (NUI) which enables the user to interact with a device in a natural manner, free from artificial constraints imposed by certain input devices such as mice, keyboards, remote controls, and the like. Examples of NUI methods include those utilizing touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems etc.

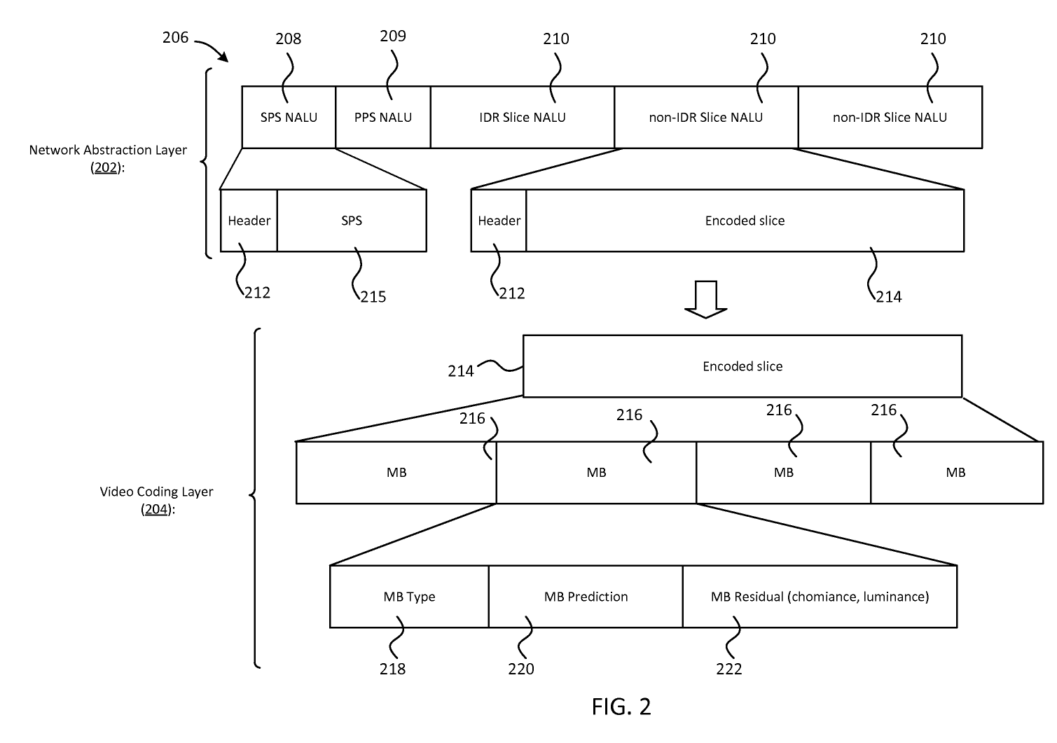

FIG. 2 illustrates a part of a packet stream 206, at the Network Abstraction Layer 202, in accordance with the H.264 standard. The stream 206 comprises a mixture of non-VCL NALUs 208, 209 and VCL NALUs 210.

VCL NALUs 210 have payloads, each comprising a piece of the encoded video content, specifically an encoded frame slice 214; the non-VLC NALUs have payloads, which comprise additional information associated with the encoded slices, such as parameter sets 215.

There are two types of parameter sets: sequence parameter sets (SPSs), which apply to a series of consecutive coded video frames (coded video sequence); and picture parameter sets (PPSs), which apply to the decoding of one or more individual frames within a coded video sequence. An SPS NALU 208 (resp. PPS NALU 209) has a payload which contains an SPS (resp. PPS).

An SPS contains information that is needed to correctly decode and display the VCL NALUs to which it applies. Specifically, the SPS contains parameters which indicate (among other things) the frame rate of the video content to which it relates, the resolution of the video content to which it relates, the maximum number of short-term and long term reference frames, profile and level data, etc. A “level” is a specified set of constraints that indicate a degree of required decoder performance for a profile. A “profile” is a (sub)set of encoding capabilities defined by the standard; when a particular profile is indicted in the SPS, this indicates that the encoder has not used capabilities outside of that (sub)set.

Each VCL NALU contains an SPS identifier which identifies, and thus links that VCL NALU, to a related SPS (i.e. the SPS containing parameters which apply to that VCL NALU); it also contains a similar PPS identifier which links it to a related PPS.

An SPS or PPS can be sent to the decoder before the VCL NALUs to which it relates. The SPS/PPS may be periodically updated by including fresh SPS/PPS NALUs in the stream, which are then passed through to the decoder. Thus, the encoder has the freedom to vary parameters for different parts of the stream 206, e.g. to achieve better quality or compression, by e.g. inserting a new SPS/PPS in the stream 206.

At the Video Coding Layer 204, an encoded slice 214 comprises sets of encoded macroblocks 216, one set for each macroblock in the slice, which may be inter or intra encoded. Each set of macroblock data 216 comprises an identifier of the type 218 of the macroblock i.e. inter or intra, an identifier 220 of a reference macroblock relative to which the macroblock is encoded (e.g. which may comprise a motion vector), and the residual 222 of the macroblock, which represents the actual values of the samples of the macroblock relative to the reference in the frequency domain. Each set of macroblock data 216 may also comprise other parameters, such as a quantization parameter of the quantization applied to the macroblock by the encoder.

One type of VCL NALU is an IDR (Instantaneous Decoder Refresh) NALU, which contains an encoded IDR slice. An IDR slice contains only intra-encoded macroblocks and the presence of an IDR slice indicates that future slices encoded in the stream will not use any slices earlier than the IDR slice as a reference i.e. so that the decoder is free to discard any reference frames it is currently holding as they will no longer be used as references. Another type of VCL NALU is a non-IDR NALU, which contains a non-IDR slice. A non-IDR slice can contain inter-encoded macroblocks and/or intra-encoded macroblocks, and does not provide any such indication.

The NALUs 208, 209, 210 also have headers 212, which among other things indicate the type the NALU e.g. identifying it as an SPS NALU, PSP NALU, IDR NALU, non-IDR NALU etc.

The H.264 protocol defines certain syntax elements in the form of SPS NALU parameters which can be included in an SPS, and for which the following syntax is used:
1. pic_width_in_mbs_minusa (frame height parameter)
2. pic_height_in_mbs_minus 1 (frame width parameter)
3. aspect_ratio_idc (aspect ratio display parameter)
4. frame_cropping_flag (cropping flag parameter)
5. frame_crop_top_offsets (top crop parameter)
6. frame_crop_bottom_offsets (bottom crop parameter)
7. frame_crop_left_offset (left crop parameter)
8. frame_crop_right_offset (right crop parameter)

The frame width and height parameters are parameters of the encoded video content itself, in the sense that they describe inherent characteristics of the video content to which the SPS relates. Specifically, they indicate the column height H and row width W of the encoded frames to which the SPS relates respectively, as measured in units of macroblocks, each macroblock being 16×16 pixels. That is, these parameters ultimately define the pixel width and height of the related video frames, albeit expressed in units of macroblocks. These parameters are defined by the H.264 protocol such that a value of “x” means a frame width or frame height of “x−1” macroblocks.

The aspect ratio display parameter is a display parameter in the sense that it does not describe an inherent characteristic of the video content, but rather a manner in which the video content is intended to be displayed. Specifically, the aspect ratio display parameter indicates an aspect ratio at which the video content should be displayed on a display, i.e. a desired ratio between the horizontal distance occupied by the video on the display itself to the vertical distance occupied by the video on the display itself, irrespective of the inherent aspect ratio W:H of the video frames as defined above. Note that the desired aspect ratio as indicated by the aspect ratio display parameter may or may not match the actual aspect ratio; to accommodate the latter, the video may be scaled disproportionately when displayed accordingly. The aspect ratio display parameter is not required by the H.264 standard—where omitted, the decoder will display the decoded video at its actual aspect ratio i.e. without any disproportionate scaling. Note that the display aspect ratio parameter is defined relative to the actual aspect ratio W:H as defined above. For instance, where the actual aspect ratio is 11; 9, aspect_ratio_idc being set to 12:11 tells the decoder that the video should be displayed with an aspect ratio of (11*12:9*11)=4:3. That is, aspect_ratio_idc=12:11 indicates a desired display aspect ratio of 4:3 for 11:9 video.

Note also that the aspect ratio display parameter may be set indirectly i.e. by reference to other parameters in the same SPS. In particular, H.264 defines “sar_width” and “sar_height” parameters, and aspect_ratio_idc can be set relative to these as aspect_ratio_idc=Extended_SAR, which means a display aspect ratio of “sar_height:sar_width”.

H.264 only permits encoding of video content having resolution which is an integer number of macroblocks, a macroblock being 16×16 pixels in H.264 (other video protocols impose similar restrictions). That is, the frames must be an integer number of macroblocks in both width and height.

However, sometimes the uncompressed, video content which is desired to be encoded does not conform to this requirement. In this scenario, the best the encoder can do is deliberately encode some additional “unwanted” pixels so as to make up the width and/or height to an integer number of macroblocks. For example, when it is desired to encode a 60×64 pixel video frame, the best the encoder can do is encode a 64×64 pixel frame which includes the desired 60×64 pixels but also has some extra unwanted pixels to make up the width to 64 pixels. The unwanted pixels could be “real” pixels e.g. as captured by a camera if the 60×64 pixels are a sub region of a larger video frame, for instance a region encompassing a face, or they could be artificially generated “filler” pixels e.g. zero-valued pixels.

These unwanted pixels will be decoded by the decoder along with the desired pixels. However, the H.264 standard provides various cropping parameters (4. to 8. above) to enable the encoder to identify the unwanted pixels to the decoder to nonetheless prevent the identified unwanted pixels from actually being displayed; that is, which can be set to indicate that the identified pixels should be cropped out once the video content has been decoded. The cropping flag parameter is a binary-valued parameter; when set to “0” (non-crop state), this indicates that the video content should not be cropped at all i.e. that the video content once decoded should be displayed in its entirety. Thus when the decoder detects that the cropping flag in an SPS is set to zero, the decoder displays the related frames in their entirety once decompressed. When the cropping flag is set to “1” (crop state), this indicates that there are unwanted pixels in the encoded video content and that some cropping of the video content should occur before it is deployed. These unwanted pixels are actually identified by including one or more of the top/bottom/left/right crop parameters, set to an appropriate value, in the SPS. For instance, if in the above example the encoder makes up the width of the video content to 64 pixels by including a column of width 4 pixels at the far left of the video content, it can include the “crop left” parameter in the relevant SPS, set to a value of “4” (i.e. 4 pixels) to indicate that the four left-most columns of the related video frames should be cropped out before the video frames are displayed.

In other words, the H.264 (and other similar standards) define cropping parameters which are intended to be used by the encoder to signal, to the decoder, that it has had to include some unwanted filler pixels in the encoded video content to which the SPS relates. Without these cropping parameters, the encoder would have no way of informing the decoder of the presence of these unwanted pixels, and decoder would have no way of knowing that any of the pixels which it has decoded are in fact unwanted.

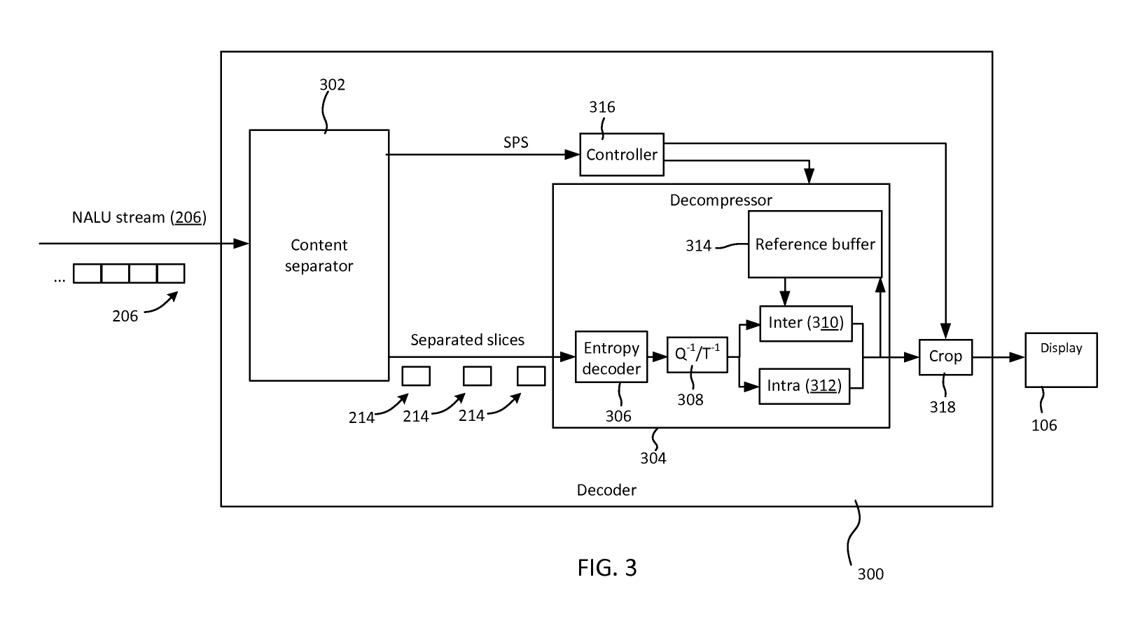

FIG. 3 shows a function block diagram of a video decoder 300, the functionality of which is implemented by running the client 112 on the processor 108 of the user device 104 (although dedicated hardware implementations and combined dedicated hardware/software implementations are not excluded). The decoder 300 comprises a content separator 302, a controller 316, a video decompressor 304, and a cropping module 318 which has a first input connected to an output of the decompressor 304.

The video decoder comprises an entropy decoder 306, an inverse quantization and transform module 308, an inter frame decoder 310, an intra frame decoder 312 and a reference slice buffer 314, which cooperate to implement a video decompression process.

The content separator 302 has an input by which it receives the stream 206, which stream 206 it processes to separate the encoded slices 214 from the rest of the stream 206. The content separator 302 has a first output by which it supplies the separated slices 214 to the decompressor 304, which decodes the separated slices 214 on a per-slice basis. The entropy decoder 306 has an input connected to the first output of the content separator 302, and is configured to reverse the entropy encoding applied at the encoder. The inverse quantization and transformation module 308 has an input connected to an output of the entropy decoder, by which it receives the entropy decoded slices, and applies inverse quantization and inverse transformation to restore the macroblocks in each slice to their spatial domain representation. To complete the decompression, either inter-frame or intra-frame decoding is applied to the macroblocks in each slice as appropriate to decompress the slices, and the decompressed slices outputted from the decompressor 304 to the cropping module 318. Decompressed slices are also selectively supplied to the slice reference buffer 314, in which they are held for use by the inter-frame decoder 310.

The content separator 302 also separates control data, such as parameter sets and any supplemental information from the rest of the stream 206. The content separator 302 has a second output connected to an input of the controller 316, by which is supplies the parameter sets and supplemental information to the controller 416. The controller 316 controls the video decompression process based on the parameter sets/supplemental information.

The controller 316 also controls the cropping module 318 based on cropping parameters received in the stream 206. Specifically, the controller 316 controls the cropping module 318 to crop each decompressed frame in accordance with the cropping parameters received in its related SPS. That is, any pixels identified as unwanted by the related SPS are removed from the decompressed video content before the decompressed video content is supplied to the display 106.

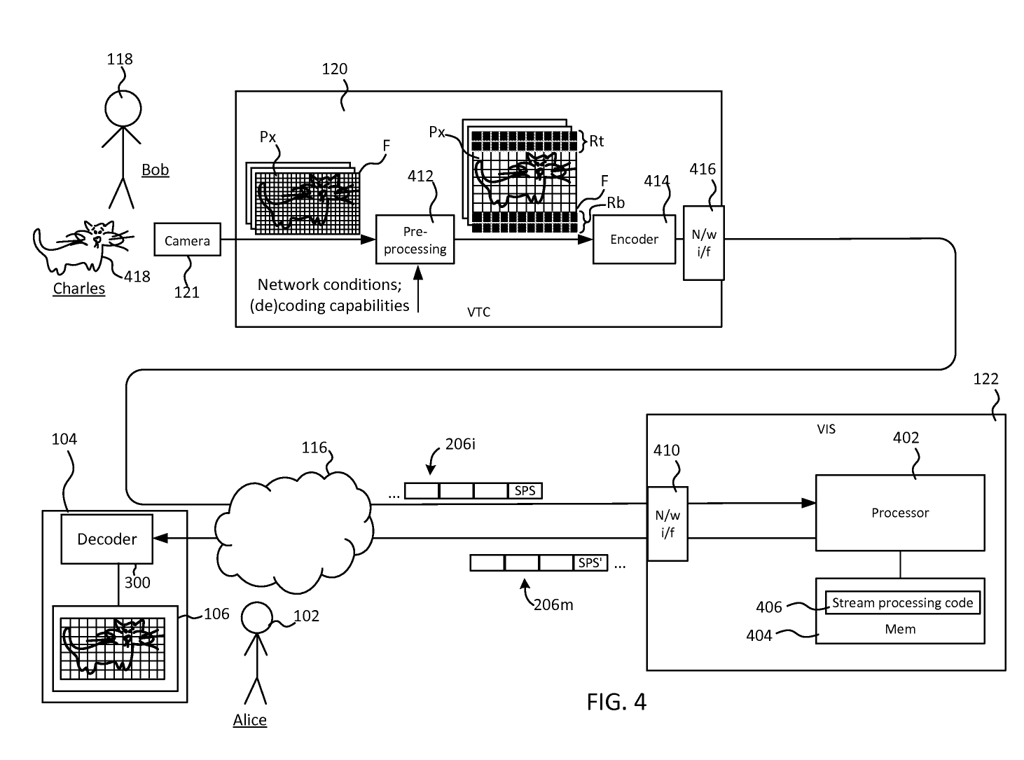

This disclose presents a novel application of the H.264, and similar cropping parameters provided by other video protocols, to provide interoperability between different video types of video calling technologies, for instance inter-operating between a software-client based system (e.g. the known Microsoft® Lync® system) and third-party VTC hardware, for instance as provided by the known entity “Cisco Systems”. This will now be described with reference to FIG. 4.

FIG. 4 illustrates the manner in which the VTC 120, VIS 122 and decoder 300 of the user device 104 cooperate during a video call between Alice 102, using her user device 104, and Bob 118, using the VTC 120. Bob's call video is captured by the camera 112 of the VTC 120, which camera is shown temporarily directed towards Bob's cat 418 (Charles) by way of example. A first channel is established between the VTC 120 and VIS 122, as is a second channel between the VIS 122 and the user device 104. The channels are via the network 116 and Bob's call video is streamed via the first channel as an initial NALU stream 206i to the VIS 122. The VIS provides interoperability between the VTC 120 and the client 112. For example, where the VTC transmits and receives video according to a first communication protocol, and the client 112 transmits and receives video according to a second, different and incompatible communication protocol, the VIS 122 performs protocol conversion to enable a video call to be conducted between the otherwise incompatible systems.

As described in detail below, the VIS modifies the initial stream 206i and transmits the modified stream 206m to the user device 104 via the second channel. Bob's call video is streamed in real-time to Alice via the VIS 122. The VTC 120 and client 112 both use the same video protocol (e.g. H.264), but may for instance use different communication protocols. Thus, it is not necessary for the VIS 122 to perform video transcoding to provide interoperability as Bob's call video is already in a format compatible with Bob's equipment and vice versa; the aforementioned modification is restricted to control data contained in the stream and is performed for reasons described in detail below.

The VTC 120 comprises a pre-processing module 412, having an input connected to the camera 121, and a video encoder 414, having an input connected to an output of the pre-processing component 412 and an output connected to a network interface 416 of the VTC. The components 412, 414 are implemented as software i.e. as code executed on a processor (not shown) of the VTC, though dedicated hardware implementations or combined dedicated hardware/software implementations are not excluded.

The call video is captured by the camera 121 comprises a plurality of video frames F, which are outputted by the camera 121 in a digital form. As such, each of the frames F is in the form of a respective array of pixels Px having values which constitute desired image data (in this example, images of Charles). As will be apparent, the pixels shown in FIG. 4 are not to scale in either size or number. Typically, the call video will be captured by the camera 121 in FIG. 1 with a relatively high resolution—e.g. 1024×769 resolution (again, this is just an example). Before encoding the video for streaming over the network, the pre-processing module 412 may first reduce the resolution of the call video (e.g. by discarding pixels, or combining multiple pixels into a single pixel) to a new, lower resolution, thereby reducing the overhead needed to stream the call video. The decision of whether and to what extent the resolution is reduced may be based on current network conditions, such as a currently available bandwidth of the first and second channels. That is, the new resolution in response to network conditions improving (e.g. the bandwidth increasing) or worsening (e.g. the bandwidth decreasing). Alternatively or additionally, this may be based on capabilities of the encoder 414 and/or decoder 300, which may also change over time e.g. as processing resources at the relevant become available or unavailable.

One challenge in providing (for example) Lync-VTC interoperability arises when encoding call video captured in 16:9 resolution. For legacy reasons, Cisco VTCs do not stream at 240p or 180p video directly. “Direct” in this context means opening the camera at 240p or 180p and allowing the encoder to work in input samples from captures directly, without pre-processing such as appending black bars or stretching the samples. Rather, Cisco VTCs have been observed to embed a 16:9 image into a 4:3 one by introducing black bars on top and bottom, and then resize the 4:3 image by disproportionately scaling the 4:3 image (with black bars) to either a CIF (Common Intermediate Format) or QCIF (Quarter CIF) image depending on the request from the far end. CIF and QCIF are 11:9 resolution formats, having a resolution of 352×288 and 176×144 pixels respectively.

That is, in the context of FIG. 4, when the network conditions become sufficiently poor and/or the encoding/decoding capabilities sufficiently limited, the pre-processing component 412 begins to convert the relatively high resolution call video captured by the camera 121, having a 16:9 aspect ratio, to CIF or QCIF video (i.e. having fewer pixels per frame) having a 11:9 aspect ratio. To do this, the pre-processing module 412 generates filler image data and adds the filler image data to each frames F as additional uppermost and lowermost rows Rt, Rb of the respective pixel array. As will be apparent, the additional rows added in pre-processing change the inherent aspect ratio of the video frames (as defined above). The rows R are rows of zero pixel values, which are interpreted and displayed as black. Thus the filler image data creates “black bars” at the top and bottom of each frame.

The black bar effect however does not exist in 16:9 images larger than or equal to 360p. That is, when the new pixel height is 360p or above, the pre-processing module does not convert the call video to a different resolution but instead simply reduces the resolution (where necessary) whilst maintaining the 16:9 resolution.

The resolution changes in discrete steps e.g. to/from QCIF from/to CIF, to/from CIF from/to 360p etc.

The upshot is that, for legacy reasons, certain VTCs output relatively lower resolution call video streams (having a pixel height at or below a threshold of 288 pixels), having a 11:9 aspect ratio and with black bars included at the top and bottom of each frame, in e.g. relatively poor network conditions/constrained processing environments but output relatively higher resolution call video streams (having a pixel height above the 288 pixel threshold), having 16:9 aspect ratio and no black bars, in e.g. relatively good network conditions/unconstrained processing environments. This yields poor visual experience when the VTC sending resolution changes up and down in a conference due to bandwidth fluctuation or coding/decoding capability changes, as end users may see black bars appear on and off and display video scale up and down in a call (this can occur if the UI is not equipped to handle changing aspect ratios, and instead scales all video to fit, say, a fixed available display area of the display).

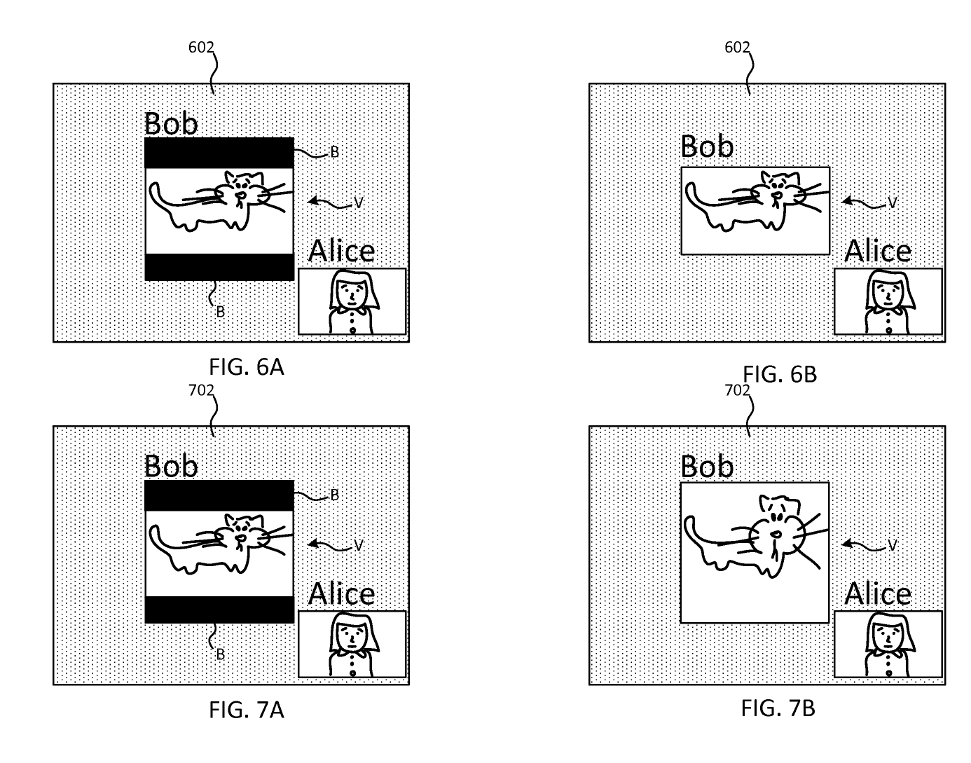

An example of this effect is illustrated in FIGS. 6A and 6B, which illustrate how a client UI 602 presented on a display may fluctuate in existing communication systems. FIG. 6A depicts the UI 602 at a point in time when a VTC is streaming video V at or below 240p e.g. in relatively poor network conditions; the presence of the black bars B is evident in the video V as displayed via the UI 602. FIG. 6B depicts the UI 602 at a different point in time when the VTC is streaming at or above 360p so that no black bars are present in the video V.

Another example of this effect is illustrated in FIGS. 7A and 7B, which illustrate how a client UI 702 presented on a display may fluctuate in existing communication systems. FIG. 7A depicts the UI 702 at a point in time when a VTC is streaming video V at or below 240p e.g. in relatively poor network conditions; the presence of the black bars B is again evident in the video V as displayed via the UI 702. FIG. 6B depicts the UI 602 at a different point in time when the VTC is streaming at or above 360p so that no black bars are present in the video V. In this case, the client UI has responded to the change in the aspect ratio of the video (i.e. the ratio between its pixel width and pixel height) by re-scaling the video horizontally so that it fills the same display area as the 240p video in FIG. 7A. This type or similar types of distortion can occur if the UI is not properly equipped to handle the change in the aspect ratio of the video.

A typical solution to tackle this black bar issue would be via full transcoding on the VIS 122 (Video Interop Server). This would mean that, when the VIS 122 detects a CIF/QCIF video sent from the VTC 120, it would have to decode the video, crop the video into a 16:9 format by cropping out the black bars, and then re-encode the cropped video. This method would involve extra video coding and processing resources on the server.

An alternative solution would for the VIS to insert meta information in the bitstream to indicate the region of black bars. The receiver could then interpret the meta information and crop out the black bars accordingly before rendering the frame. This approach however would not work for legacy clients that do not understand the meta information. That is, this would require the client logic to be updated to enable the client to interpret the new type of meta data.

This disclosure provides a cost-effective and backward compatible solution to the black-bar issue. It leverages H.264 syntax elements the frame_crop_top_offset and frame_crop_bottom_offset parameters in an SPS NAL unit to cause the black-bars to be cropped out at the decoder 300 of the receiving device 104. As this leverages H.264 standard syntax, all H.264 conformant decoders, including both HW and SW decoders, will handle it automatically, providing backwards compatibility. Note that, whilst presented in the context of H.264 by way of example, the subject matter is not H.264 specific and can be extended to e.g. VC1 and HEVC by leveraging similar syntax elements. Thus, the black-bar issue is solved without transcoding and without having to update clients currently in use.

As mentioned, these syntax elements were originally defined in H.264 spec for handling input frame height that is not a multiple of 16 pixels; however this disclosure presents a new application of these parameters to address the black bar issue.

Specifically, when the VIS 122 sees a CIF (352×288) video from the VTC 120, the VIS 122 manipulates H.264 syntax element frame_crop_top_offset and frame_crop_bottom_offset in an SPS NAL unit such that the resolution becomes 352×198 once it has been decompressed and cropped by the decoder 300 of the receiving device 104. Similarly, for QCIF (176×144) video, VIS uses the same approach to ensure that the decoder, having decompressed the video, crops it to 176×99 resolution before it is displayed on the display 106.

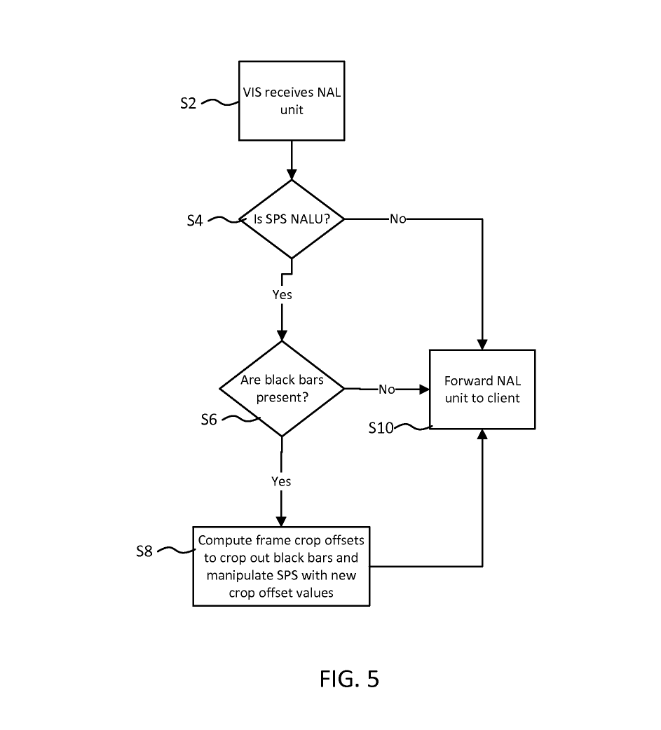

Returning to FIG. 4, the VIS is shown to comprise a processor 402, a memory 404 holding stream processing code 406, and a network interface 410. The processor 402 is connected to the memory 404 and to the network interface 410. The stream processing code is configured when executed on the processor 402 to implement a stream processing algorithm. The stream processing algorithm will now be described with reference to FIG. 5, which is a flow chart for the algorithm.

The encoder 414 operates in accordance with the H.264 standard, and there are two possible scenarios. In a first scenario, the VTC 120 encodes video having a pixel width and pixel height which are both an integer number of macroblocks; as such, as far as the standardized encoder is concerned, there is no need to make use of the cropping parameters and thus the encoder 414 sets the croping flag in the SPSs of the initial stream 206i to “0” to indicate that no cropping is necessary in the first scenario. In the first scenario, the SPSs in the initial stream 206i indicate that all of the call video, including the black bars when added, should be displayed when the video is outputted. Equally, the VTC 120 may encode video having a pixel width and/or height that is not an integer multiple of 16 pixels (second scenario). In the second scenario, the standardized encoder uses the crop offsets in the manner that they were originally intended i.e. by adding further filler (above and beyond the black bars themselves) to make up the difference, setting the cropping flag to “1” and setting the top, bottom, left and/or right cropping parameters to indicate that the additional filler (though not the black bars) should be cropped out, never cropping out more than 15 pixels from any one of the top, bottom, left or right of the frames. If any further top filler (above and beyond the black bars) is added by the encoder to the top and/or bottom of the frames, the further top filler will have a height of between 1 and 15 pixels inclusive. If any further bottom filler is added as an alternative or in addition to the further top filler, it will also have a height of between 1 and 15 pixels inclusive. This is because, when the H.264 cropping parameters are merely put to their intended use, one would never have good reason to crop out more than 15 pixels as one would never have good reason to introduce more than 15 unwanted filler pixels to make up the frame height to an integer multiple of 16 pixels.

Note that the additional filler data referred to in the preceding paragraph may be the same type of filler data as the black bars (e.g. entirely zero-values pixels), and may be added at the same time. However, the two types of filler are distinguished in that the encoder sets the cropping parameters to crop out the additional filler data, but not to crop out the black bar filler data. In other words, when operating at 240p or 180p, the VTC encoder always adds top and bottom filler data to the top and bottom of each frame, and each of the top and bottom filler data has a respective pixel height strictly greater than 15 pixels (i.e. 16 or more); however, the VTC encoder never indicates that all of this should be cropped out—it may indicate that none is to be cropped out by setting the cropping flag to “0”, or it may indicate that only some of it is to be cropped out by setting the cropping flag to “1” and the top and/or bottom cropping parameters to indicate that between 1 and 15 rows of pixels, inclusive, (and thus at most 15 pixels) are to be cropped out from the top and/or bottom of each frame. Herein, the term “black bar” refers to only that filler data which i) has been added by the encoded and ii) which the encoder has indicated should not be cropped out in the relevant SPS.

The algorithm of FIG. 5 is performed for each NALU of the initial stream 206i as received from the VTC 120. At step S2, the NALU unit is received and, at step S4, it is determined from the header of the NALU unit whether or not it is an SPS NALU (labelled SPS in FIG. 4). If so, the SPS contained therein is processed to detect whether or not there are black bars present in the video frames to which the SPS contained therein relates. That is, to detect whether or not there is any filler data in the frames which has been added by the encoder but which the encoder has not indicated should be cropped out.

This detection can be implemented by leveraging knowledge of the behaviour of the VTC 120. As described above, certain existing VTCs are known to include black bars only when streaming at a frame height at or below a threshold value of 288p, and not when streaming above the threshold value (e.g. at 360p or higher). As indicated above, the H.264 standard (and other similar standards) requires the encoder 414 of the VTC 120 to indicate, in each SPS that the encoder 414 includes in the initial stream 206i, the column height and row width of the video frames to which that SPS relates by setting the frame width and height parameters (1. and 2. above) to match the actual width and height of the frames; the encoder 414 does so accordingly. Thus, it is straightforward to determine, just by reading for example the frame height parameter in any given SPS, the height of the video frames to which it relates, and thus whether they are encoded below the threshold (i.e. in CIF or QCIF format) or above the threshold (i.e. at 360p) or above without having to look at the frames themselves. Note the frame height parameter is not the only parameter that indicates the frame height; for example, as there is a known relation between the height and the width of the frames, in other embodiments the frame width parameter could be read instead. Accordingly, in certain embodiments, the detection step of S6 is implemented by reading the frame height parameter in the SPS and determining whether it is at or below the threshold (meaning black bars are present) or above the threshold (meaning black bars are not present).

At step S8, if black bars are detected at step S6, frame crop offsets for cropping out the black bars are computed, and the SPS is modified to i) set the cropping flag to “1” if it is not “1” already, ii) to add top and bottom crop parameters to the SPS if they are not included already, and iii) to set the top and bottom crop parameters to respective values that are greater than 15 and sufficiently high to indicate that the black bars should be cropped out once the related video frames have been decoded and before they are displayed.

Where the encoder has indicated that some (but necessarily only some) of the filler data which it has been added should be cropped out, this is handled by using new crop offset values which are each a sums of the corresponding original value plus what is needed for removing the black bars.

In this case, the top and bottom crop parameters will have values greater than 15 pixels, indicating that more than 15 rows of pixels are to be cropped out from both the top and bottom of the video frames—at least 45 pixels from the top and bottom for CIF (½*(288-198)), and at least 22 (½*(144-99)) from the top and bottom for QCIF. In one sense, this is unusual in that, when the H.264 cropping parameters are merely put to their original use of handing an input video height which is not an integer multiple of 16 pixels, as discussed above, one would never have good reason to crop out more than 15 pixels as one would never have good reason to introduce more than 15 unwanted filler pixels to make up the frame height to an integer multiple of 16 pixels.

Note that, in the case that the VTC 120 has included the aspect ratio display parameter (aspect_ratio_idc) in the SPS and has set it to indicate an intended display aspect ratio of 4:3, left unchecked some existing decoders would interpret this to mean that the decoded and cropped video (having been cropped to 16:9 by the removal of top and bottom rows of pixels) should be scaled disproportionately back to 4:3 when on the displayed by scaling the video in a horizontal direction only. For this reason, the aspect ratio display parameter may also be set at step S8 match the cropping parameters included by the VIS i.e. so that the aspect ratio display parameter matches the actual aspect ratio of the remaining sub-array of uncropped pixels in each frame, thereby preventing disproportionate scaling of the video frames when displayed at the receiving device. In this example, the aspect ratio display parameter is set to indicate a desired display resolution of 16:9 (that of the frames as received at the transmitting device prior to the addition of the black bars during pre-processing). For Cisco VTCs, the inventors have observed black bars on QCIF and CIF. Furthermore, in these cases, they have found that the bitstream always contains aspect_ratio_idc set to 12:11. This suggests that the VTC firsts convert a 16:9 image to a 4:3 one by adding black bars, and stretches the 4:3 video to 11:9 (CIF/QCIF), and sets aspect_ratio to 12:11 to tell the decoder to reverse this stretching before the video is displayed.

At step S10, the modified SPS (labelled SPS' in FIG. 4) is forwarded to the client 112 running on the user device 104 as part of the modified stream 206m. The modified SPS is received by the decoder 300. The decoder 300 detects that the cropping flag is “1” in the SPS, and in response crops out the black bars as identified by the top and bottom cropping values from all video frames to which that SPS relates once those frames have been decoded. That is, modifying an SPS in this manner causes the decoder 300 to display only a respective part of each video frame to which that SPS relates (said part does not include the additional rows).

Returning to step S2, if it is determined that the NALU is not an SPS NALU, the algorithm proceeds to step S10 directly and the NALU is transmitted to the client 112 unmodified. Similarly, if at step S6 no black bars are detected in the SPS, the algorithm proceeds to step S10 and the SPS is forwarded to the client 112 unmodified.

Thus the only modification to the stream is the modification of SPS(s) which relate to video frames encoded with a 4:3 resolution. The majority of NALUs in the initial stream 206i are not SPS NALUs—most are VCL NALUs containing actual video content and a single SPS will generally apply to a relatively large number of these. Thus, the algorithm of FIG. 5 only performs substantive processing on a relatively small proportion of NALUs in the stream 206i, and thus represents efficient use of server resources.

Note that, whenever the VTC 120 changes the resolution of the streamed video, and thus whenever the VTC 120 either starts or stops including black bars, it must in accordance with the H.264 standard generate a new SPS NALU in the stream to convey the change, with the horizontal and vertical picture size parameters set to indicate the new resolution. Thus, the addition or removal of black bars will always be exactly synchronous with a new SPS in the stream which means that the addition/removal of the black bars will be detected straight away from the new SPS.

Note that the use alternative black bar detection methods at step S6 are within the scope this disclosure. For example, each video frame could be decoded at the VIS 122 and an image recognition process applied to the decoded video to detect the presence of the black bars, for instance by leveraging the fact that black pixels are repeated across frames in the same region when black bars are present. This would still represent an efficiency saving as compared with full transcoding as the video would only be decoded for detection purposes and would not need to be cropped and re-coded at the VIS 122 (the VIS 122 would still effect the eventual cropping by modifying SPS(s) where applicable, and the cropping would still be performed by the decoder 300 of the receiving device 104 as a result). That is, the decoded video content, as decoded by the VIS, is not re-encoded by the VIS or transmitted to the receiving device. Alternatively, the VIS may e.g. only decode the first few frames of a coded sequence to infer whether black frames are present for this coded sequence, or it may analyse DCT coefficients to infer the presence/size black bars instead of fully decoding a frame.

Note that an aspect ratio of “substantially W:H” means the aspect ratio is W:H to an accuracy of order one pixel.

“Real-time” means that there is only a short delay (e.g. <2 seconds) between video frames being captured at the transmitting device and played out at the receiving device, the short delay including the transmission time from the receiving device to the VIS, the processing and possible modification of the stream at the VIS, and the transmission time from the VIS to the receiving device.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, devices such as the user device 104, VTC 120 and VIS 122 may also include an entity (e.g. software) that causes hardware of the devices to perform operations, e.g., processors functional blocks, and so on. For example, the devices may include a computer-readable medium that may be configured to maintain instructions that cause the devices, and more particularly the operating system and associated hardware of the devices to perform operations. Thus, the instructions function to configure the operating system and associated hardware to perform the operations and in this way result in transformation of the operating system and associated hardware to perform functions. The instructions may be provided by the computer-readable medium to the devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

The respective array of each of the plurality of frames has a total number of rows. In embodiments of the various aspects set in the Summary section, the pre-processing by the transmitting device may further comprise reducing the resolution of the plurality of frames by at least reducing the total number of rows. The addition of said more than said predetermined number of top rows and said more than said predetermined number of bottom rows may be conditional on the reduced number being at or below a threshold (e.g. 288 rows), and the reduced number may be indicted in the control data by the transmitting device. Said processing by the stream processing code may be of the control data in the packet stream to automatically detect the filler image data by detecting that the reduced number is at or below the threshold (e.g. 288 rows).

The data stream may be of data packets having headers containing payload data, and the control data may be received as payload data contained in a control data packet. For each packet in the received stream, the stream processing code may determine from the header of that packet whether or not that packet is a control data packet and, if not, transmit that packet to the receiving device without modifying the payload data contained in that packet.

The data stream may be formatted according to the H.264 standard, HEVC standard, SMPTE VC-1 standard, or any other protocol which provides a Network Abstraction Layer (NAL) unit structure.

The packets are may be NAL units, and said control data packet bay be a sequence parameter set (SPS) NAL unit and, for each NAL unit in the received stream, the stream processing code may determine from the header of that NAL unit whether or not that NALU unit is an SPS NAL unit and, if not, transmit that NAL unit to the receiving device without modifying the payload data contained in that NALU unit.

Said modification by the stream processing code may further comprise setting an aspect ratio display parameter in the control data to match the modified cropping data (e.g. by setting it to 16:9), thereby preventing disproportionate scaling of the plurality of video frames when displayed at the receiving device. The aspect ratio of each of the plurality of frames after pre-processing may for example be substantially 11:9.

The video content may be call video of a call between a user of the receiving device and another user of the transmitting device, the packet stream being transmitted from the transmitting device to the relay server and modified by the stream processing code, and the modified stream being transmitted from the relay server to the receiving device, in real-time. That is, the stream processing code may be configured to perform said processing, modification and transmission in real-time.

The cropping data may be generated by the transmitting device is in the form of: a cropping flag set to a crop state, and a top and a bottom cropping parameter set to indicate that between one and said predetermined number of topmost rows, inclusive, and between one and said predetermined number of bottommost rows, inclusive, should be cropped out before the plurality of video frames is displayed respectively; the cropping data may be modified by setting the top and bottom cropping parameters to indicate that all of the additional rows should be cropped out before the plurality of video frames is displayed.

The cropping data generated by the transmitting device is in the form of a cropping flag set to a non-crop state and thereby indicating that each of the plurality of frames, including the additional rows, should be displayed in its entirety when video content is outputted; the cropping data may be modified by setting the cropping flag to a crop state and adding a top and a bottom cropping parameter to the control data to indicate that all of the additional rows should be cropped out before the plurality of video frames is displayed.

The stream processing code may decode at least part of the video content from the received stream, and automatically detected the filler image data performing image recognition on the decoded at least part of the video content.

Said predetermined number may be 15.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for relaying video content from a transmitting device to a receiving device of a communication system, the method comprising:
at the transmitting device:
receiving video content to be transmitted to the receiving device, the video content comprising a plurality of frames, each of the plurality of frames formed of a respective array of desired image data to be displayed at the receiving device;
pre-processing the video content to add filler image data to each of the plurality of frames as more than a predetermined number of additional rows at the top and more than said predetermined number of additional rows at the bottom of the respective array;
encoding the pre-processed video content;
generating control data for decoding and displaying the plurality of frames, the control data comprising cropping data indicating that between zero and said predetermined number of topmost rows, inclusive, and between zero and said predetermined number of bottommost rows, inclusive, should be cropped out of each of the plurality of frames before the plurality of frames is displayed, thereby indicating that at least some of the additional rows should be displayed when the video content is outputted; and
transmitting the encoded video content and the control data as a packet stream to a video relay server of the system;
at the video relay server:
receiving the packet stream; and
executing stream processing code on a processor of the video relay server to:
process at least part of the received packet stream to automatically detect the filler image data,
in response to said detection, modify the packet stream by modifying the cropping data to indicate that all of the additional rows should be cropped out of each of the plurality of frames before the plurality of frames is displayed, and
transmit the modified stream to the receiving device.

2. A method according to claim 1 wherein the respective array of each of the plurality of frames has a total number of rows, wherein the pre-processing by the transmitting device further comprises reducing the resolution of the plurality of frames by at least reducing the total number of rows, wherein the addition of said more than said predetermined number of top rows and said more than said predetermined number of bottom rows is conditional on the reduced number being at or below a threshold, and wherein the reduced number is indicted in the control data by the transmitting device; and
wherein said processing by the stream processing code is of the control data in the packet stream to automatically detect the filler image data by detecting that the reduced number is at or below the threshold.

3. A method according to claim 2 wherein the data stream is of data packets having headers containing payload data, wherein the control data is received as payload data contained in a control data packet, and wherein, for each packet in the received stream, the stream processing code determines from the header of that packet whether or not that packet is a control data packet and, if not, transmits that packet to the receiving device without modifying the payload data contained in that packet.

4. A method according to claim 1 wherein the data stream is formatted according to the H.264 standard, HEVC standard, SMPTE VC-1 standard, or any other protocol which provides a Network Abstraction Layer (NAL) unit structure.

5. A method according to claim 3 wherein the packets are NAL units, said control data packet is a sequence parameter set (SPS) NAL unit and, for each NAL unit in the received stream, the stream processing code determines from the header of that NAL unit whether or not that NALU unit is an SPS NAL unit and, if not, transmits that NAL unit to the receiving device without modifying the payload data contained in that NALU unit.

6. A method according to claim 2 wherein the threshold is 288 rows.

7. A method according to claim 1 wherein said modification by the stream processing code further comprises setting an aspect ratio display parameter in the control data to match the modified cropping data, thereby preventing disproportionate scaling of the plurality of video frames when displayed at the receiving device.

8. A method according to claim 1 wherein the aspect ratio display parameter is set to substantially 16:9.

9. A method according to claim 8 wherein the aspect ratio of each of the plurality of frames after pre-processing is substantially 11:9.

10. A method according to claim 1 wherein the video content is call video of a call between a user of the receiving device and another user of the transmitting device, the packet stream being transmitted from the transmitting device to the relay server and modified by the stream processing code, and the modified stream being transmitted from the relay server to the receiving device, in real-time.

11. A method according to claim 1 wherein the cropping data generated by the transmitting device is in the form of: a cropping flag set to a crop state, and a top and a bottom cropping parameter set to indicate that between one and said predetermined number of topmost rows, inclusive, and between one and said predetermined number of bottommost rows, inclusive, should be cropped out before the plurality of video frames is displayed respectively; and
wherein the cropping data is modified by setting the top and bottom cropping parameters to indicate that all of the additional rows should be cropped out before the plurality of video frames is displayed.

12. A method according to claim 1 wherein the cropping data generated by the transmitting device is in the form of a cropping flag set to a non-crop state and thereby indicating that each of the plurality of frames, including the additional rows, should be displayed in its entirety when video content is outputted; and
wherein the cropping data is modified by setting the cropping flag to a crop state and adding a top and a bottom cropping parameter to the control data to indicate that all of the additional rows should be cropped out before the plurality of video frames is displayed.

13. A method according to claim 1 further comprising the stream processing code decoding at least part of the video content from the received stream, the filler image data automatically detected by the stream processing code performing image recognition on the decoded at least part of the video content.

14. A method according to claim 1 wherein said predetermined number is 15.

15. A method according to claim 1 wherein the video content further comprises another plurality of frames, each of the other plurality of frames also formed of a respective array of desired image data to be displayed at the receiving device, wherein between zero and said predetermined number of further top rows of filler data, inclusive, and between zero and said predetermined number of further bottom rows of filler data, inclusive, is added to the other plurality of frames by the transmitting device when the video content is pre-processed, wherein the method further comprises:
generating at the transmitting device additional control data for decoding and displaying the other plurality of frames, the additional control data comprising additional cropping data indicating that all of the further top and bottom rows should be cropped out of the additional video frames, the additional control data also being included in the data stream; and
the stream processing code processing at least another part of the received stream to detect that there is no filler data in the other plurality of video frames which the further control data does not already indicate should be cropped out and, in response, transmitting the additional control data to the receiving device unmodified.

16. A video relay server comprising:
a network interface configured to receive a packet stream from a transmitting device, the packet stream comprising encoded video content, the video content comprising a plurality of frames, and control data for decoding and displaying the plurality of video frames, each of the plurality of video frames having been formed, prior to said encoding, of a respective array of desired image data, the plurality of video frames having been pre-processed prior to said encoding to add filler image data to each of the plurality of frames as more than a predetermined number of additional rows at the top and more than said predetermined number of additional rows at the bottom of the respective array, wherein the received control data comprises cropping data indicating that between zero and said predetermined number of topmost rows, inclusive, and between zero and said predetermined number of bottommost rows, inclusive, should be cropped out of each of the plurality of frames before the plurality of video frames is displayed, thereby indicating that at least some of the additional rows should be displayed when the video content is outputted;
a processor; and
a memory holding stream processing code, the stream processing code configured when executed to:
process at least part of the received packet stream to automatically detect the filler image data,
in response to said detection, modify the packet stream by modifying the cropping data to indicate that all of the additional rows should be cropped out of each of the plurality of video frames before the plurality of video frames is displayed, and
transmit, via the network interface, the modified stream to a receiving device.

17. A server according to claim wherein the respective array of each of the plurality of frames has a total number of rows, wherein the pre-processing by the transmitting device further comprises reducing the resolution of the plurality of frames by at least reducing the total number of rows, wherein the addition of said more than said predetermined number of top rows and said more than said predetermined number of bottom rows is conditional on the reduced number being at or below a threshold, and wherein the reduced number is indicted in the control data by the transmitting device; and
wherein said processing by the stream processing code is of the control data in the packet stream to automatically detect the filler image data by detecting that the reduced number is at or below the threshold.

18. A server according to claim 17 wherein the data stream is a stream of data packets having headers containing payload data, wherein the control data is received as payload data contained in a control data packet, and wherein, for each packet in the received stream, the stream processing code is configured to determine from the header of that packet whether or not that packet is a control data packet and, if not, transmit that packet to the receiving device without modifying the payload data contained in that packet.

19. A server according to claim 14 wherein the video content is call video of a call between a user of the receiving device and another user of the transmitting device, wherein the stream processing code is configured to perform said processing, modification and transmission in real-time.

20. A computer program product comprising stream processing code stored on a computer readable storage medium, the stream processing code to be executed on a processor of a video relay server, the video relay server configured to receive a packet stream from a transmitting device, the packet stream comprising encoded video content, the video content comprising a plurality of frames, and control data for decoding and displaying the plurality of video frames, each of the plurality of video frames having been formed, prior to said encoding, of a respective array of desired image data, the plurality of video frames having been pre-processed prior to said encoding to add filler image data to each of the plurality of frames as more than a predetermined number of additional rows at the top and more than said predetermined number of additional rows at the bottom of the respective array, wherein the received control data comprises cropping data indicating that between zero and said predetermined number of topmost rows, inclusive, and between zero and said predetermined number of bottommost rows, inclusive, should be cropped out of each of the plurality of frames before the plurality of video frames is displayed, thereby indicating that at least some of the additional rows should be displayed when the video content is outputted, wherein the stream processing code is configured when executed on the processor to:
process at least part of the received packet stream to automatically detect the filler image data,
in response to said detection, modify the packet stream by modifying the cropping data to indicate that all of the additional rows should be cropped out of each of the plurality of video frames before the plurality of video frames is displayed, and
transmit the modified stream to a receiving device.
